(19) United States
(12) Patent Application Publication
(10) Pub. No.: US 2025/0170916 A1
(43) Pub. Date: May 29, 2025

(54) ELECTRIC VEHICLE BATTERY CHARGING VOLTAGE CONTROL APPARATUS AND METHOD

(71) Applicants: HYUNDAI MOTOR COMPANY, Seoul (KR); Kia Corporation, Seoul (KR)

(72) Inventors: Sang Jin LEE, Hwaseong-si (KR); KyungHyun LIM, Hanam-si (KR)

(73) Assignees: HYUNDAI MOTOR COMPANY, Seoul (KR); Kia Corporation, Seoul (KR)

(21) Appl. No.: 18/782,495

(22) Filed: Jul. 24, 2024

(30) Foreign Application Priority Data
Nov. 29, 2023 (KR) 10-2023-0168835

(51) Int. Cl. B60L 53/62; B60L 53/65; H01M 10/42; H01M 10/44; H01M 10/48; H02J 7/00

(52) U.S. Cl. CPC B60L 53/62; B60L 53/65; H01M 10/4221; H01M 10/44; H01M 10/48; H02J 7/00047; H01M 2220/20

(57) ABSTRACT

Provided is an electric vehicle battery charging voltage control apparatus including: a battery type determinator receiving a battery type and a battery charging start signal of an electric vehicle from a battery sensor operatively connected to the battery type determinator; a charging mode determinator operatively connected to the battery type determinator and configured for determining a battery charging mode in which an optimal charging voltage for each battery type is set based on the battery charging start signal and the battery type; and a charging voltage controller operatively connected to the battery type determinator and the charging mode determinator and compensating for the optimal charging voltage set based on the battery charging mode and setting a compensation charging voltage based on current battery durability determined based on durability determination logic based on a change in an output voltage of a battery which is set for each battery type.

### CROSS-REFERENCE TO RELATED APPLICATION

The present application claims priority to Korean Patent Application No. 10-2023-0168835 filed on Nov. 29, 2023, the entire contents of which is incorporated herein for all purposes by this reference.

### BACKGROUND OF THE PRESENT DISCLOSURE

### Field of the Present Disclosure

The present disclosure relates to electric vehicle battery charging voltage control apparatus and method, and more particularly, to electric vehicle battery charging voltage control apparatus and method which may improve battery durability by setting an optimal charging voltage based on a battery type.

### Description of Related Art

Unlike an existing internal combustion engine, there are conditions that an electric vehicle requires its charging not only while driving but also while parked. Among the conditions, control of supplementary charging (logic for charging a 12V battery by use of a high-voltage battery through a low direct current (DC)-to-direct current (DC) converter (LDC)) when the 12V battery has a low charge rate) is required to improve battery durability.

Due to the difficulty in dualizing hardware specifications of the LDC, a charging voltage for the supplementary charging may use the same value rather than a value classified for each battery type. Accordingly, for example, the charging voltage may be less than a required value when using a specification of a complete maintenance free (CMF) battery, thus causing a phenomenon such as a longer charging time.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing electric vehicle battery charging voltage control apparatus and method which may improve durability of a battery by setting an optimal charging voltage classified for each battery type during supplementary charging of the battery and appropriately controlling the set optimal charging voltage based on the durability of the battery.

According to an exemplary embodiment of the present disclosure, provided is an electric vehicle battery charging voltage control apparatus including: a battery type determinator receiving a battery type and a battery charging start signal of an electric vehicle from a battery sensor operatively connected to the battery type determinator; a charging mode determinator operatively connected to the battery type determinator and configured for determining a battery charging mode in which an optimal charging voltage for each battery type is set based on the battery charging start signal and the battery type; and a charging voltage controller operatively connected to the battery type determinator and the charging mode determinator and compensating for the optimal charging voltage set based on the battery charging mode and setting a compensation charging voltage based on current battery durability determined based on durability determination logic based on a change in an output voltage of a battery which is set for each battery type.

The battery charging start signal may be a supplementary charging start signal of the battery using a high-voltage battery which is generated when the vehicle is not driving.

The battery type may include an absorbent glass mat (AGM) battery, a complete maintenance free (CMF) battery, and a lithium battery.

The charging voltage controller may be configured to determine that the current battery durability is in a normal state when the current output voltage of the battery is greater than a predetermined reference voltage set for each battery type, determine that the current battery durability is in an intermediate state when the current output voltage of the battery is the same as the predetermined reference voltage, and determine that the current battery durability is in a lower state when the current output voltage of the battery is less than the predetermined reference voltage.

The charging voltage controller may set the compensation charging voltage to a first compensation charging voltage which is the same as the optimal charging voltage determined based on the battery charging mode when the current battery durability is in the normal state.

The charging voltage controller may determine, as a second compensation charging voltage, a compensation voltage value subtracted from the optimal charging voltage determined based on the battery charging mode by a difference between a maximum output voltage of the battery and the predetermined reference voltage of the battery when the current battery durability is in the intermediate state.

The charging voltage controller may determine, as a third compensation charging voltage, a durability improvement charging voltage predetermined for each battery type when the current battery durability is in the lower state.

The charging voltage controller may be configured to conclude that the durability improvement charging voltage is the same as the compensation voltage value.

The charging voltage controller may stop an operation of power generation control of the vehicle which is performed using the battery when the current battery durability is in the lower state.

According to another exemplary embodiment of the present disclosure, provided is an electric vehicle battery charging voltage control method including: receiving a battery type and a battery charging start signal of an electric vehicle from a battery sensor; determining a battery charging mode in which an optimal charging voltage is set for each battery type based on the battery charging start signal and the battery type; determining current battery durability based on durability determination logic based on a change in an output voltage of a battery which is set for each battery type; and setting a compensation charging voltage for compensating for the optimal charging voltage set based on the battery charging mode based on the determined current battery durability.

The determining of the battery charging mode may further include determining whether the battery charging start signal is a supplementary charging start signal of the battery using a high-voltage battery which is generated when the vehicle is not driving.

The determining of the battery charging mode may further include determining the battery charging mode corresponding to the different optimal charging voltage for each battery type including an absorbent glass mat (AGM) battery, a complete maintenance free (CMF) battery, and a lithium battery.

The determining of the current battery durability may further include determining that the current battery durability is in a normal state when the current output voltage of the battery is greater than a predetermined reference voltage set for each battery type, determining that the current battery durability is in an intermediate state when the current output voltage of the battery is the same as the predetermined reference voltage, and determining that the current battery durability is in a lower state when the current output voltage of the battery is less than the predetermined reference voltage.

The setting of the compensation charging voltage may further include setting the compensation charging voltage to a first compensation charging voltage which is the same as the optimal charging voltage determined based on the battery charging mode when the current battery durability is in the normal state.

The setting of the compensation charging voltage may further include determining, as a second compensation charging voltage, a compensation voltage value subtracted from the optimal charging voltage determined based on the battery charging mode by a difference between a maximum output voltage of the battery and the predetermined reference voltage of the battery when the current battery durability is in the intermediate state.

The setting of the compensation charging voltage may further include determining, as a third compensation charging voltage, a durability improvement charging voltage predetermined for each battery type when the current battery durability is in the lower state.

The determining of the third compensation charging voltage may further include concluding that the third compensation charging voltage is the same as the compensation voltage value.

The setting of the compensation charging voltage may further include stopping an operation of power generation control of the vehicle which is performed using the battery when the current battery durability is in the lower state.

As set forth above, the electric vehicle battery charging voltage control apparatus and method may improve the durability of the battery by setting the optimal charging voltage classified for each battery type during the supplementary charging of the battery and appropriately controlling the set optimal charging voltage based on the durability of the battery.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 schematically shows an electric vehicle battery charging structure according to an exemplary embodiment of the present disclosure.

FIG. 2 is a view briefly showing an electric vehicle battery charging control system according to an exemplary embodiment of the present disclosure.

FIG. 3 is a block diagram of an electric vehicle battery charging voltage control apparatus according to an exemplary embodiment of the present disclosure.

FIG. 4 is a flowchart of an electric vehicle battery charging voltage control method according to another exemplary embodiment of the present disclosure.

FIG. 5 is a flowchart of the electric vehicle battery charging voltage control method according to another exemplary embodiment of the present disclosure.

FIG. 6 is a graph showing charging voltage control based on a change in an output voltage of a battery according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure are described in detail with reference to the accompanying drawings for those skilled in the art to which the present disclosure pertains to easily practice the present disclosure. However, the present disclosure may be modified in various different forms, and is not limited to the exemplary embodiments provided herein. Furthermore, in the drawings, portions unrelated to the description are omitted to clearly describe the present disclosure, and similar portions are denoted by similar reference numerals throughout the specification.

Through the specification and the claims, unless explicitly described otherwise, “including” any components will be understood to imply the inclusion of another component rather than the exclusion of another component. Terms including ordinal numbers such as “first,” “second” and the like, may be used to describe various components. However, these components are not limited by these terms. The terms are used only to distinguish one component from another component.

Terms such as “˜part”, “˜er/or”, and “module” described in the specification may refer to a unit configured for processing at least one function or operation described in the specification, which may be implemented as hardware, a circuit, software, or a combination of hardware or circuit and software.

Hereinafter, the exemplary embodiments of the present disclosure are described with reference to the drawings.

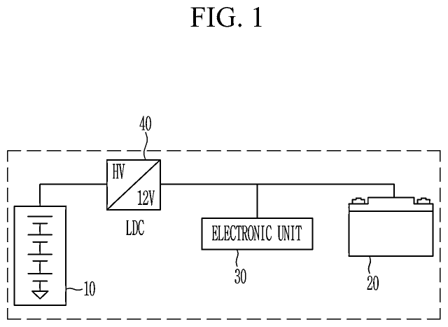

FIG. 1 schematically shows an electric vehicle battery charging structure according to an exemplary embodiment of the present disclosure.

Referring to FIG. 1, the electric vehicle battery charging structure may include a high-voltage battery 10, a battery 20, an electronic unit 30, and a low direct current (DC)-to-direct current (DC) converter (LDC) 40.

The battery 20 applied to an electric vehicle may use a 12V battery. The 12V battery 20 may receive power from the high-voltage battery 10 through the LDC 40. Based on such a structural feature, the LDC 40 controlling charging/discharging for the battery 20 may include a vehicle battery charging voltage control apparatus implemented with charging/discharging control logic for the battery 20.

The Battery 20 may have various battery types based on its type. The battery type may be classified based on function application. The battery 20 may include a structural difference based on the battery type. The battery 20 may have different performance and malfunction based on the battery type.

The vehicle battery charging voltage control apparatus may reflect the battery type and battery durability when charging the battery 20.

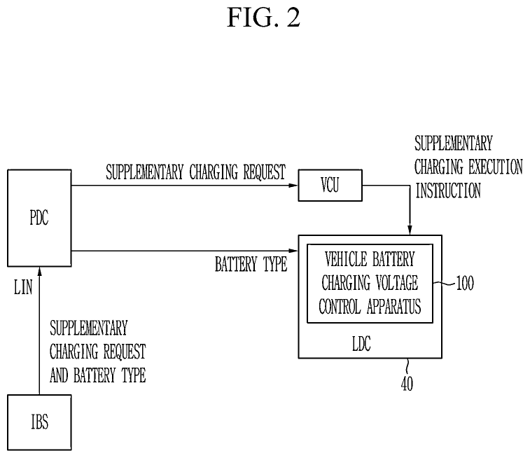

FIG. 2 is a view briefly showing an electric vehicle battery charging control system according to an exemplary embodiment of the present disclosure.

In an exemplary embodiment of the present disclosure, the electric vehicle battery charging control system may include an intelligent battery sensor (IBS), a powernet domain controller (PDC), a vehicle controller (VCU), and a vehicle battery charging voltage control apparatus 100 included in the LDC 40.

The vehicle battery charging voltage control apparatus 100 may perform a vehicle battery charging voltage control method (or logic) for controlling a charging voltage by considering the battery type and the battery durability when charging the battery.

As shown in FIG. 2, the IBS may transmit a supplementary charging request signal and information on the battery type to the PDC through a Local Interconnect Network (LIN). The battery type may include an absorbent glass mat (AGM) battery, a complete maintenance free (CMF) battery, and a lithium battery.

The PDC may transmit the received supplementary charging request signal to the VCU through Controller Area Network (CAN) communication. The PDC may transmit the information on the battery type to the vehicle battery charging voltage control apparatus 100 of the LDC 40 through the CAN communication.

The VCU may receive the supplementary charging request signal and issue a supplementary charging execution instruction including a supplementary charging start signal to the vehicle battery charging voltage control apparatus 100.

The vehicle battery charging voltage control apparatus 100 may be configured for controlling the charging voltage during supplementary charging of the vehicle battery based on the received supplementary charging start signal and battery type.

According to an exemplary embodiment of the present disclosure, each of the powernet domain controller (PDC), the vehicle controller (VCU), and the vehicle battery charging voltage control apparatus 100 may be implemented by a processor (e.g., computer, microprocessor, CPU, ASIC, circuitry, logic circuits, etc.). Each of the powernet domain controller (PDC), the vehicle controller (VCU), and the vehicle battery charging voltage control apparatus 100 may be implemented by a non-transitory memory storing, e.g., a program(s), software instructions reproducing algorithms, etc., which, when executed, controls operations of various components of the vehicle, and a processor configured to execute the program(s), software instructions reproducing algorithms, etc. Alternatively, the powernet domain controller (PDC), the vehicle controller (VCU), and the vehicle battery charging voltage control apparatus 100 may be integrated in a single processor.

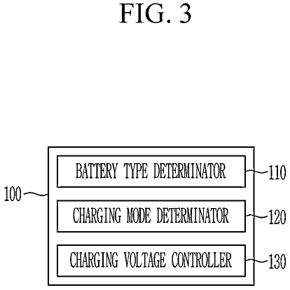

FIG. 3 is a block diagram of the electric vehicle battery charging voltage control apparatus 100 according to an exemplary embodiment of the present disclosure.

Referring to FIG. 3, the vehicle battery charging voltage control apparatus 100 may include a battery type determinator 110, a charging mode determinator 120, and a charging voltage controller 130.

The battery type determinator 110 may receive the battery type and a battery charging start signal of the electric vehicle from the battery sensor IBS (see FIG. 2). The battery type determinator 110 may be configured to determine the battery type of the battery to be charged based on the information on the battery type which is received from the IBS. In an exemplary embodiment of the present disclosure, the battery charging start signal may be the supplementary charging start signal of the battery using the high-voltage battery which is generated when the vehicle is not driving.

The charging mode determinator 120 may be configured to determine a battery charging mode based on the battery charging start signal and the battery type. For example, the charging mode determinator 120 may confirm the battery type when determining the supplementary charging start signal of the battery. When determining the battery type, the charging mode determinator 120 may be configured to determine the battery charging mode corresponding to the determined battery type.

In the battery charging mode, an optimal charging voltage may be set based on the battery type. That is, the charging mode determinator 120 may set the optimal charging voltage based on the battery charging mode determined based on the battery charging start signal and the battery type.

Here, the optimal charging voltage may be a voltage reflecting a required voltage value determined based on the battery type when supplementary charging the battery. It is possible to reduce a charging time, improve the battery durability, and extend a battery lifespan when supplementary charging the battery with the optimal charging voltage. For example, the optimal charging voltage may be 15.4V to 16V for the AGM battery and 14.4V to 14.8V for the CMF battery.

The charging voltage controller 130 may be configured to determine current battery durability based on durability determination logic based on a change in an output voltage of the battery which is set for each battery type. The durability determination logic may be configured to determine the battery durability based on a magnitude of the output voltage of the battery based on a predetermined specific reference voltage.

The charging voltage controller 130 may perform control to compensate for the optimal charging voltage based on the predetermined battery type, based on the determined current battery durability, and set a compensation charging voltage.

The charging voltage controller 130 may be configured to conclude that the battery durability is in a normal state when the current output voltage of the battery is greater than the specific reference voltage set for each battery type.

Here, the output voltage may be an open circuit voltage (OCV) of the battery. The output voltage or the OCV may be reduced in response to the maximum charging amount reduced as the battery durability is lower. For example, when the maximum charging amount of the battery is reduced from 100% to 80% based on the durability, the output voltage of the battery may also be reduced to a level of 80%.

The charging voltage controller 130 may be configured to conclude that the battery durability is in an intermediate state when the current output voltage of the battery is the same as the specific reference voltage.

The charging voltage controller 130 may be configured to conclude that the battery durability is in a lower state when the current output voltage of the battery is less than the specific reference voltage.

In an exemplary embodiment of the present disclosure, the specific reference voltage may signify a predetermined reference voltage or a predetermined reference voltage range having an upper limit and a lower limit.

For example, the specific reference voltage may be 12.4V to 12.54V. Therefore, the charging voltage controller 130 may be configured to conclude that the battery durability is in the normal state when the current output voltage of the battery is greater than 12.54V. The charging voltage controller 130 may be configured to conclude that the durability is in the intermediate state when the current output voltage of the battery is in a range of 12.4V to 12.54V based on the battery durability. The charging voltage controller 130 may be configured to conclude that the battery durability is in the lower state when the current output voltage of the battery is less than 12.4V based on the battery durability.

The charging voltage controller 130 may set the compensation charging voltage to a first compensation charging voltage which is the same as the optimal charging voltage determined based on the battery charging mode when the current battery durability is in the normal state.

The charging voltage controller 130 may determine, as a second compensation charging voltage, a compensation voltage value subtracted from the optimal charging voltage by a difference between the maximum output voltage of the battery and the specific reference voltage of the battery when the current battery durability is in the intermediate state.

Here, the maximum output voltage of the battery may be the output voltage of the battery that corresponds to 100% of a charging amount of the battery in a new product state before the battery durability is lower.

For example, when the battery type of the battery is the CMF battery, the maximum output voltage of the battery may be 12.9V, and the specific reference voltage which is the same as the current output voltage may be 12.5V. In the instant case, the charging voltage controller 130 may determine, as the compensation voltage value of the battery, 15V to 15.6V obtained by subtracting 0.4V, which is the difference between the maximum output voltage and the specific reference voltage, from 15.4V to 16V, which is the optimal charging voltage of the CMF battery.

Therefore, the charging voltage controller 130 may determine, as the second compensation charging voltage, 15V to 15.6V obtained by applying the compensated compensation voltage value to the optimal charging voltage based on battery durability determination.

The charging voltage controller 130 may determine, as a third compensation charging voltage, a durability improvement charging voltage predetermined for each battery type when the current battery durability is in the lower state. The durability improvement charging voltage may include a predetermined reference voltage value to improve the battery durability.

For example, the charging voltage controller 130 may be configured to conclude that the durability improvement charging voltage is the same as the compensation voltage value. Alternatively, the charging voltage controller 130 may be configured to determine the durability improvement charging voltage as the same as the predetermined optimal charging voltage of the battery.

The charging voltage controller 130 may stop an operation of power generation control of the vehicle which is performed using the battery to thus improve the battery durability when the current battery durability is in the lower state.

The power generation control of the vehicle may increase power generation efficiency by appropriately controlling an output of an alternator which is configured to perform power generation by use of a rotational power of an engine, based in a state of the battery or the like, improving vehicle fuel efficiency.

For example, the power generation control using the battery may minimize fuel consumption by charging and storing a regenerative energy, which is generated during deceleration of the vehicle, in the battery, and reducing a power generation amount of the alternator which consumes engine power by use of the energy charged in the battery during the acceleration, constant speed, and idle state of the vehicle.

According to an exemplary embodiment of the present disclosure, each of the battery type determinator 110, the charging mode determinator 120, and the charging voltage controller 130 may be implemented by a processor (e.g., computer, microprocessor, CPU, ASIC, circuitry, logic circuits, etc.). Each of the battery type determinator 110, the charging mode determinator 120, and the charging voltage controller 130 may be implemented by a non-transitory memory storing, e.g., a program(s), software instructions reproducing algorithms, etc., which, when executed, controls operations of various components of the vehicle, and a processor configured to execute the program(s), software instructions reproducing algorithms, etc. Alternatively, the battery type determinator 110, the charging mode determinator 120, and the charging voltage controller 130 may be integrated in a single processor.

According to an exemplary embodiment of the present disclosure, each of the battery type determinator 110, the charging mode determinator 120, and the charging voltage controller 130 may be implemented by a processor (e.g., computer, microprocessor, CPU, ASIC, circuitry, logic circuits, etc.). Each of the battery type determinator 110, the charging mode determinator 120, and the charging voltage controller 130 may be implemented by a non-transitory memory storing, e.g., a program(s), software instructions reproducing algorithms, etc., which, when executed, controls operations of various components of the vehicle, and a processor configured to execute the program(s), software instructions reproducing algorithms, etc. Alternatively, the battery type determinator 110, the charging mode determinator 120, and the charging voltage controller 130 may be integrated in a single processor.

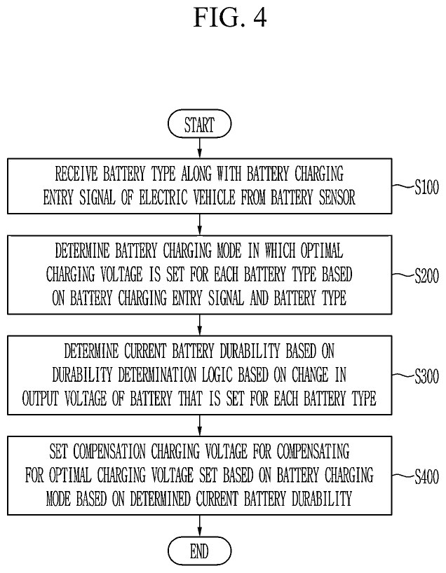

FIG. 4 is a flowchart of an electric vehicle battery charging voltage control method according to another exemplary embodiment of the present disclosure. The electric vehicle battery charging voltage control method of FIG. 4 may be performed by an electric vehicle battery charging voltage control apparatus 100 (see FIG. 2).

As shown in FIG. 4, the vehicle battery charging voltage control apparatus 100 may receive a battery type and a battery charging start signal of an electric vehicle from a battery sensor (S100).

The vehicle battery charging voltage control apparatus 100 may be configured to determine a battery charging mode in which an optimal charging voltage is set for each battery type based on the battery charging start signal and the battery type (S200).

The vehicle battery charging voltage control apparatus 100 may be configured to determine current battery durability based on durability determination logic based on a change in an output voltage of a battery which is set for each battery type (S300).

The vehicle battery charging voltage control apparatus 100 may set a compensation charging voltage for compensating for the optimal charging voltage set based on the battery charging mode based on the determined current battery durability (S400).

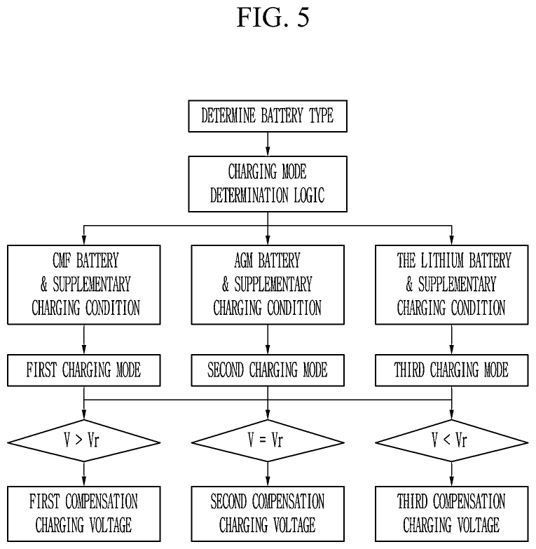

FIG. 5 is a flowchart of the electric vehicle battery charging voltage control method according to another exemplary embodiment of the present disclosure. The electric vehicle battery charging voltage control method of FIG. 5 may be performed by the electric vehicle battery charging voltage control apparatus 100 (see FIG. 2).

As shown in FIG. 5, the vehicle battery charging voltage control apparatus 100 may confirm whether the battery charging start signal is a supplementary charging start signal of the battery using a high-voltage battery which is generated when the vehicle is not driving.

The vehicle battery charging voltage control apparatus 100 may be configured to determine the battery type of the battery based on information on the battery type which is received from an intelligent battery sensor (IBS).

The vehicle battery charging voltage control apparatus 100 may be configured to determine the battery charging mode in which the different optimal charging voltage is provided for each battery type and which includes an absorbent glass mat (AGM) battery, a complete maintenance free (CMF) battery, and a lithium battery.

The battery charging mode may be determined based on the charging start signal as well as the battery type. For example, the vehicle battery charging voltage control apparatus 100 may be configured to determine the battery charging mode based on each battery type when receiving the supplementary charging start signal based on a charging condition.

That is, the vehicle battery charging voltage control apparatus 100 may be configured to determine the battery charging mode for each battery type. The battery charging mode may include a first charging mode, a second charging mode, and a third charging mode. The first, second, and third charging modes may respectively be determined to correspond to the different battery types.

For example, the first charging mode may be set when the battery type is the CMF battery. The second charging mode may be set when the battery type is the AGM battery. The third charging mode may be set when the battery type is the lithium battery.

The first, second, and third charging modes may respectively include the different optimal charging voltages. For example, the first charging mode may correspond to the CMF battery, and set the optimal charging voltage to 14.4V to 14.8V. The second charging mode may correspond to the AGM battery, and set the optimal charging voltage to 15.4V to 16V.

The vehicle battery charging voltage control apparatus 100 may be configured to determine that the battery durability is in a normal state when a current output voltage V of the battery is greater than a predetermined specific reference voltage Vr, determine that the battery durability is in an intermediate state when the current output voltage V is the same as the specific reference voltage Vr, and determine that the battery durability is in a lower state when the current output voltage V is less than the specific reference voltage Vr.

Here, the different specific reference voltage Vr may be set for each of the first, second, and third charging modes.

The vehicle battery charging voltage control apparatus 100 may set the compensation charging voltage as a first compensation charging voltage which is the same as the optimal charging voltage determined based on the battery charging mode when the current battery durability is in the normal state.

That is, the vehicle battery charging voltage control apparatus 100 may continue its charging with the optimal charging voltage without performing compensation control when the current battery durability is in the normal state.

The vehicle battery charging voltage control apparatus 100 may determine, as a second compensation charging voltage, a compensation voltage value subtracted from the optimal charging voltage determined based on the battery charging mode by a difference between the maximum output voltage of the battery and the specific reference voltage of the battery when the current battery durability is in the intermediate state.

That is, the vehicle battery charging voltage control apparatus 100 may be configured to determine the compensation voltage value from the optimal charging voltage by considering the current battery durability during the charging to determine the second compensation charging voltage, and progress the charging with the second compensation charging voltage.

The vehicle battery charging voltage control apparatus 100 may determine, as a third compensation charging voltage, a durability improvement charging voltage predetermined for each battery type when the current battery durability is in the lower state.

That is, the vehicle battery charging voltage control apparatus 100 may improve the durability by progressing the charging with the predetermined durability improvement charging voltage by considering the durability. For example, the durability improvement charging voltage may be set to be the same as the optimal charging voltage for each battery type.

The vehicle battery charging voltage control apparatus 100 may stop an operation of power generation control of the vehicle which is performed using the battery when the current battery durability is in the lower state.

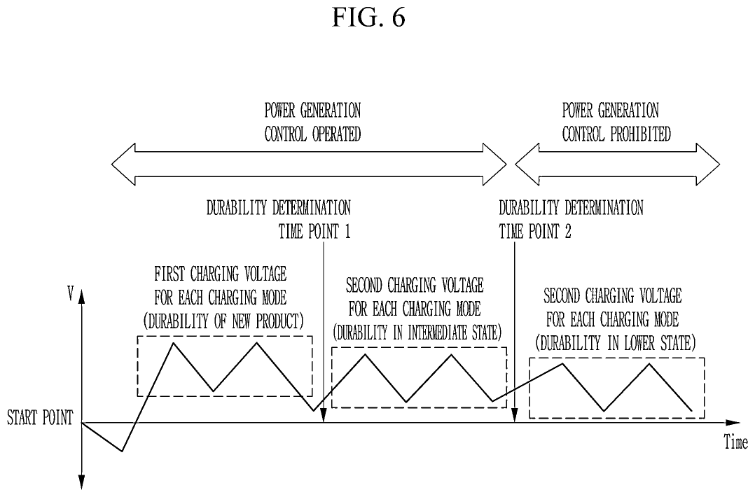

FIG. 6 is a graph showing charging voltage control based on the change in the output voltage of the battery according to an exemplary embodiment of the present disclosure.

FIG. 6 is a graph showing the change in the output voltage or open circuit voltage (OCV) of the battery over time. FIG. 6 is a graph for explaining whether the power generation control is operated based on the battery charging voltage control and durability determination based on the change in the output voltage of the battery.

Referring to FIG. 6, it may be seen that the output voltage V of the battery is gradually reduced from a start point of the vehicle over time. The output voltage of the battery may be gradually reduced as the battery durability is lower over time.

That is, a first charging voltage based on the battery charging mode when the battery is a new product may be greater than a second charging voltage based on the charging mode when the durability is in the intermediate state or the lower state. The second charging voltage when the durability is in the intermediate state or the lower state may be the same as reflecting a compensation value to the first charging voltage. Alternatively, the second charging voltage when the durability is in the lower state may be less than the second charging voltage when the durability is in the intermediate state.

The operation of the battery power generation control may be operated until a durability determination time point 2 and may not be operated thereafter. The durability determination time point 2 may be determined based on the output voltage of the battery at a corresponding time point. Therefore, the battery power generation control may be prohibited after the durability determination time point 2 determined by the specific output voltage.

That is, the vehicle battery charging voltage control apparatus 100 may correspond to the output voltage of the battery which is reduced over time, and vary the charging voltage during the supplementary charging. Furthermore, the vehicle battery charging voltage control apparatus 100 may prohibit the power generation control of the battery after a specific time point (e.g., the durability determined time point 2) when the output voltage of the battery is less than a specific output voltage of the battery.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

Hereinafter, the fact that pieces of hardware are coupled operably may include the fact that a direct and/or indirect connection between the pieces of hardware is established by wired and/or wirelessly.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An electric vehicle battery charging voltage control apparatus comprising:
a battery type determinator receiving a battery type and a battery charging start signal of an electric vehicle from a battery sensor operatively connected to the battery type determinator;
a charging mode determinator operatively connected to the battery type determinator and configured for determining a battery charging mode in which an optimal charging voltage for each battery type is set based on the battery charging start signal and the battery type; and
a charging voltage controller operatively connected to the battery type determinator and the charging mode determinator and compensating for the optimal charging voltage set based on the battery charging mode and setting a compensation charging voltage based on current battery durability determined based on durability determination logic based on a change in an output voltage of a battery which is set for each battery type.

2. The apparatus of claim 1, wherein the battery charging start signal is a supplementary charging start signal of the battery using a high-voltage battery which is generated in response that the electric vehicle is not driving.

3. The apparatus of claim 1, wherein the battery type includes an absorbent glass mat (AGM) battery, a complete maintenance free (CMF) battery, and a lithium battery.

4. The apparatus of claim 1, wherein the charging voltage controller is further configured to conclude that the current battery durability is in a normal state in response that a current output voltage of the battery is greater than a predetermined reference voltage set for each battery type, to conclude that the current battery durability is in an intermediate state in response that the current output voltage of the battery is the same as the predetermined reference voltage, and to conclude that the current battery durability is in a lower state in response that the current output voltage of the battery is less than the predetermined reference voltage.

5. The apparatus of claim 4, wherein the charging voltage controller is further configured to set the compensation charging voltage to a first compensation charging voltage which is the same as the optimal charging voltage determined based on the battery charging mode in response that the current battery durability is in the normal state.

6. The apparatus of claim 4, wherein the charging voltage controller is further configured to determine, as a second compensation charging voltage, a compensation voltage value subtracted from the optimal charging voltage determined based on the battery charging mode by a difference between a maximum output voltage of the battery and the predetermined reference voltage of the battery in response that the current battery durability is in the intermediate state.

7. The apparatus of claim 6, wherein the charging voltage controller is further configured to determine, as a third compensation charging voltage, a durability improvement charging voltage predetermined for each battery type in response that the current battery durability is in the lower state.

8. The apparatus of claim 7, wherein the charging voltage controller is further configured to conclude that the durability improvement charging voltage is the same as the compensation voltage value.

9. The apparatus of claim 4, wherein the charging voltage controller is further configured to stop an operation of power generation control of the electric vehicle which is performed using the battery in response that the current battery durability is in the lower state.

10. An electric vehicle battery charging voltage control method comprising:
receiving, by a controller, a battery type and a battery charging start signal of an electric vehicle from a battery sensor;
determining, by the controller, a battery charging mode in which an optimal charging voltage is set for each battery type based on the battery charging start signal and the battery type;
determining, by the controller, current battery durability based on durability determination logic based on a change in an output voltage of a battery which is set for each battery type; and
setting, by the controller, a compensation charging voltage for compensating for the optimal charging voltage set based on the battery charging mode based on the determined current battery durability.

11. The method of claim 10, wherein the determining of the battery charging mode further includes:
determining whether the battery charging start signal is a supplementary charging start signal of the battery using a high-voltage battery which is generated in response that the electric vehicle is not driving.

12. The method of claim 10, wherein the determining of the battery charging mode further includes:
determining the battery charging mode corresponding to different optimal charging voltage for each battery type including an absorbent glass mat (AGM) battery, a complete maintenance free (CMF) battery, and a lithium battery.

13. The method of claim 10, wherein the determining of the current battery durability further includes:
concluding that the current battery durability is in a normal state in response that a current output voltage of the battery is greater than a predetermined reference voltage set for each battery type, concluding that the current battery durability is in an intermediate state in response that the current output voltage of the battery is the same as the predetermined reference voltage, and concluding that the current battery durability is in a lower state in response that the current output voltage of the battery is less than the predetermined reference voltage.

14. The method of claim 13, wherein the setting of the compensation charging voltage further includes:
setting the compensation charging voltage to a first compensation charging voltage which is the same as the optimal charging voltage determined based on the battery charging mode in response that the current battery durability is in the normal state.

15. The method of claim 13, wherein the setting of the compensation charging voltage further includes:
determining, as a second compensation charging voltage, a compensation voltage value subtracted from the optimal charging voltage determined based on the battery charging mode by a difference between a maximum output voltage of the battery and the predetermined reference voltage of the battery in response that the current battery durability is in the intermediate state.

16. The method of claim 15, wherein the setting of the compensation charging voltage further includes:
determining, as a third compensation charging voltage, a durability improvement charging voltage predetermined for each battery type in response that the current battery durability is in the lower state.

17. The method of claim 16, wherein the determining of the third compensation charging voltage further includes:
concluding that the third compensation charging voltage is the same as the compensation voltage value.

18. The method of claim 13, wherein the setting of the compensation charging voltage further includes:
stopping an operation of power generation control of the electric vehicle which is performed using the battery in response that the current battery durability is in the lower state.
